(19) United States
(12) Patent Application Publication
(10) Pub. No.: US 2025/0149555 A1
(43) Pub. Date: May 8, 2025

(54) ELECTRODE AND METHOD OF MANUFACTURE

(71) Applicant: Echion Technologies Limited, Cambridge (GB)

(72) Inventors: Wanwei Zhang, Cambridge (GB); Joshua Lewis, Cambridge (GB); Alexander Groombridge, Cambridge (GB)

(73) Assignee: Echion Technologies Limited, Cambridge (GB)

(21) Appl. No.: 18/838,143

(22) PCT Filed: Feb. 23, 2023
(86) PCT No.: PCT/GB2023/050416

§ 371 Date: Aug. 13, 2024

(30) Foreign Application Priority Data
Feb. 23, 2022 (GB) 2202454.1

(51) Int. Cl. H01M 4/36; C01G 33/00; H01M 4/02; H01M 4/04; H01M 4/48; H01M 4/587; H01M 10/0525; H01M 10/054

(52) U.S. Cl. CPC H01M 4/366; C01G 33/00; H01M 4/0404; H01M 4/0459; H01M 4/48; H01M 4/587; H01M 10/0525; H01M 10/054; C01P 2002/72; C01P 2004/03; C01P 2004/52; C01P 2004/61; C01P 2004/62; C01P 2006/12; C01P 2006/40; C01P 2006/80; H01M 2004/021

(57) ABSTRACT

The invention relates to a method of making an electrode, the method comprising: providing a starting H—Nb₂O₅ material; jet milling and classifying the starting material to provide a processed H—Nb₂O₅ material having a D₅₀ particle diameter of 2.2-15 μm and a particle size distribution span (D₉₀−D₁₀/D₅₀ of <1.90; and forming an electrode comprising the processed H—Nb₂O₅ material as an active electrode material.

### FIELD OF THE INVENTION

The present invention relates to electrodes comprising niobium oxide and methods for making the same. Such electrodes are of interest for use in as metal-ion batteries, such as lithium-ion or sodium-ion batteries, preferably as anodes in lithium-ion batteries.

### BACKGROUND

Lithium-ion (Li-ion) batteries are a commonly used type of rechargeable battery with a global market predicted to grow to $200 bn by 2030. Li-ion batteries are the technology of choice for electric vehicles that have multiple demands across technical performance to environmental impact, providing a viable pathway for a green automotive industry.

A typical lithium-ion battery is composed of multiple cells connected in series or in parallel. Each individual cell is usually composed of an anode (negative polarity electrode) and a cathode (positive polarity electrode), separated by a porous, electrically insulating membrane (called a separator), immersed into a liquid (called an electrolyte) enabling lithium ions transport. In most systems, the electrodes are composed of an active electrode material—meaning that it is able to chemically react with lithium ions to store and release them reversibly in a controlled manner—mixed if necessary with an electrically conductive additive (such as carbon) and a polymeric binder. A slurry of these components is coated as a thin film on a current collector (typically a thin foil of copper or aluminium), thus forming the electrode upon drying.

In the traditional Li-ion battery technology, the safety limitations of graphite anodes upon battery charging are a serious impediment to its application in high-power electronics, automotive and industry. Various polymorphs of niobium oxide have previously been demonstrated as Li-ion battery materials. In 1981, Reichman and Bard (B. Reichman and A. J. Bard, “The Application of Nb2O5 as a Cathode in Nonaqueous Lithium Cells”, J. Electrochem. Soc., 128, 344, 1981) firstly demonstrated the electrochemical performance of niobium oxide in lithium-ion cells as a cathode material. Later in 1983, Cava et al. (R. J. Cava, D. W. Murphy, and S. M. Zahurak, “Lithium Insertion in Wadsley-Roth Phases Based on Niobium Oxide,” J. Electrochem. Soc., vol. 130, no. 12, pp. 2345-2351, 1983) studied lithium-inserted Wadsley-Roth phases in niobium oxides. In 1994, Koshiba et al. (N. Koshiba, K. Takata, M. Nakanishi, and Z. Takehara, “Evaluation of crystalline Nb₂O₅ as an anode of rechargeable lithium cell”, Denki Kagaku, vol. 62, no. 7, pp. 593-601, 1994) studied different niobium oxide polymorphs from calcination of niobium chloride at different temperatures as anode materials for Li-ion batteries. More recently, Griffith et al. (K. J. Griffith, A. C. Forse, J. M. Griffin, and C. P. Grey, “High-Rate Intercalation without Nanostructuring in Metastable Nb₂O₅ Bronze Phases,” J. Am. Chem. Soc., vol. 138, no. 28, pp. 8888-8899, 2016) studied a variety of micro-sized niobium oxide polymorphs synthesised from heating NbO₂ as anode materials, finding that capacity and rate performance of low-temperature bronze-phase TT- and T-polymorphs are inherent properties of the bulk crystal structure. Li et al. (“A Niobium Oxide with Shear Structure and Planar Defects for High-Power Lithium Ion Batteries,” Energy Environ. Sci., 2021) prepared micrometer-sized H—Nb₂O₅ with rich Wadsley planar defects by adjusting the calcination temperature for fast lithium storage. They further tested the effect of particle size on cell performance for well-crystallized H—Nb₂O₅, obtaining a smaller particle size by means of roller milling. Cell results suggested that the particle size reduction gave little improvement. In WO2021/245411 niobium oxide is mixed with an oxide of the general formula M1ₐM2₁₋ₐM3_{b}Nb_{12-b}O_{33-c-d}Q_{d}. EP0402687B1 relates to a niobium oxide powder of >90% of the T-phase, having a fluorine value <1000 ppm, >99.9% by weight passes through a 45 μm sieve, with a BET surface area larger than 3.5 m²/g, for application in ceramic capacitors.

In summary, although it does have some promising properties, niobium oxide is said to have intrinsically poor electronic conductivity and to suffer from capacity decay resulting from pulverisation during charge-discharge, which limits its practical application in lithium-ion batteries. Specifically, the Wadsley-Roth H—Nb₂O₅ polymorph exhibits the highest specific capacities but shows the lowest capacity retention at high charge/discharge rates due to increasing impedance (cf. polarisation) effects. The low-temperature bronze-type polymorphs T-Nb₂O₅ and TT-Nb₂O₅ on the other hand show higher capacity retention at high charge/discharge rates but suffer in their lower specific capacities. With more reduced forms of niobium oxide, such as NbO₂, a large increase in electrical conductivity can be shown as the material becomes semi-conducting, however the ability to intercalate Li-ions is lost as the material no longer bears the Wadsley-Roth or Bronze crystal structure types believed to be favourable. Typical approaches to addressing these problems rely on extensive nanoscale or particle-level engineering, increasing manufacturing complexity. Accordingly, there remains a need for more efficient methods of optimising niobium oxides for use as active electrode materials

### SUMMARY OF THE INVENTION

In a first aspect, the invention provides a method of making an electrode, the method comprising: providing a starting H—Nb₂O₅ material; jet milling and classifying the starting material to provide a processed H—Nb₂O₅ material having a D₅₀ particle diameter of 2.2-15 μm and a particle size distribution span (D₉₀−D₁₀)/D₅₀ of <1.90; and forming an electrode comprising the processed H—Nb₂O₅ material as an active electrode material.

It has been found that processing H—Nb₂O₅ using jet milling and classification to achieve the specific particle size parameters provides a surprising improvement when compared to the use of other milling methods and to other particle size parameters. For instance, as shown by the present examples, control of the milling method and of the particle size distribution of the processed H—Nb₂O₅ material has been shown to improve the capacity of H—Nb₂O₅ when acting as an active electrode material even when delithiated at high rates of e.g. 5 C and 10 C. These are important results in demonstrating the advantages of the invention for providing electrodes for use in high-power batteries designed for fast charge/discharge.

In a second aspect, the invention provides a method of making an electrochemical cell, the method comprising making an electrode by following the method of the first aspect, and forming an electrochemical cell comprising the electrode. Preferably the electrode forms the anode of the electrochemical cell. Preferably the electrochemical cell is a metal-ion battery such as a lithium-ion or a sodium-ion battery, most preferably a lithium-ion battery.

The invention provides electrodes and electrochemical cells obtainable from the first and second aspects.

### SUMMARY OF THE FIGURES

FIG. 1. Particle size distribution of Examples 1-6

FIG. 2. XRD of Examples 1-6

FIG. 3. SEM of powders of Examples 1, 2, 5, and 6

FIG. 4: SEM of electrodes obtained using powders of Examples 1, 2, and 6

FIG. 5. Particle size distribution of Examples 7-9

FIG. 6. SEM of powders of Examples 7-9

FIG. 7. SEM of electrodes obtained using powders of Examples 7-9

FIG. 8: XRD of Examples 7-9

### DETAILED DESCRIPTION OF THE INVENTION

The starting material used in the process is H—Nb₂O₅, which is a polymorph of Nb₂O₅ having a Wadsley-Roth crystal structure. Wadsley-Roth crystal structures are considered to be a crystallographic off-stoichiometry of the MO₃ (ReO₃) crystal structure containing crystallographic shear, with simplified formula of MO₃₋ₓ. As a result, these structures typically contain [MO₆]octahedral subunits in their crystal structure alongside others. The H—Nb₂O₅ crystal structure has an array of octahedral units arranged in a block structure, with a combination of both (3×4)₁ and (3×5)∞ ReO₃-like blocks. The blocks are infinite parallel to b, and the subscripts 1 and ∞ denote block connectivity in the ac plane. Further information on crystal structures of Nb₂O₅ may be found at Griffith et al., J. Am. Chem. Soc. 2016, 138, 28, 8888-8899. The crystal structure of a material may be determined by analysis of X-ray diffraction (XRD) patterns, as is widely known. For instance, XRD patterns obtained from a given material can be compared to known XRD patterns to confirm the crystal structure, e.g. via public databases such as the ICDD crystallography database. Rietveld analysis and Pawley analysis can also be used to determine the crystal structure of materials, in particular for the unit cell parameters. The crystal structure of H—Nb₂O₅ is available at ICDD crystallography database entry JCPDS 37-1468.

The starting H—Nb₂O₅ material may have a phase purity of >80 wt % H—Nb₂O₅, >90 wt % H—Nb₂O₅, or >95 wt %, or about 100 wt % H—Nb₂O₅. Phase purity refers to the proportion of the Nb₂O₅ that adopts the H—Nb₂O₅ crystal structure as opposed to other crystal structures of Nb₂O₅. Phase purity may be determined by X-ray diffraction. The starting H—Nb₂O₅ material may be substantially pure H—Nb₂O₅, for example it may contain unavoidable impurities arising due to the manufacturing process. The starting H—Nb₂O₅ material may be doped with additional cations and/or anions, provided that the crystal structure corresponds to the H—Nb₂O₅ crystal structure. The term ‘corresponds’ can be understood to mean that that peaks in an X-ray diffraction pattern may be shifted by no more than 0.5 degrees (preferably shifted by no more than 0.25 degrees, more preferably shifted by no more than 0.1 degrees) from corresponding peaks in the reference X-ray diffraction pattern.

The starting H—Nb₂O₅ material may be obtained from commercial suppliers. Alternatively, the starting H—Nb₂O₅ material may be made by annealing a niobium oxide precursor (e.g. NbO₂, other polymorphs of Nb₂O₅, Nb₂O₅ hydrates) in air at above 900° C., e.g. at 1100-1300° C. The formation of H—Nb₂O₅ may then be confirmed by XRD. The annealing time may be at least 30 minutes, or at least 1 hour. The starting material is typically obtained at relatively large particle sizes unsuitable for use as an active electrode material. For example, the starting H—Nb₂O₅ material may have a D₅₀ particle diameter of >20 μm, 25-150 μm, or 30-100 μm.

The term “particle diameter” refers to the equivalent spherical diameter (esd), i.e. the diameter of a sphere having the same volume as a given particle, where the particle volume is understood to include the volume of any intra-particle pores. The terms “Dₙ” and “Dₙ particle diameter” refer to the diameter below which n % by volume of the particle population is found, i.e. the terms “D₅₀” and “D₅₀ particle diameter” refer to the volume-based median particle diameter below which 50% by volume of the particle population is found. Where a material comprises primary crystallites agglomerated into secondary particles, it will be understood that the particle diameter refers to the diameter of the secondary particles. Particle diameters can be determined by laser diffraction. Particle diameters can be determined in accordance with ISO 13320:2009, for example using Mie theory.

The starting H—Nb₂O₅ material typically has a relatively low surface area. For example, the starting material may have a BET surface area of <0.8 m²/g or <0.6 m²/g. The term “BET surface area” refers to the surface area per unit mass calculated from a measurement of the physical adsorption of gas molecules on a solid surface, using the Brunauer-Emmett-Teller theory. For example, BET surface areas can be determined in accordance with ISO 9277:2010.

The starting H—Nb₂O₅ material is jet milled and classified. Jet milling is a powder comminution technique, where powered material is accelerated by high pressure gas or steam and cause inter-particle collisions to reduce the particle size. Two common designs are spiral jet mills and fluidised-bed jet mills. A spiral jet mill typically has a cylindrical grinding chamber with several gas nozzle presented in the direction of a tangent. Selection of particles sizes is carried out by the aerodynamic properties of the particles and the spiral design, which gives good control of fineness. A fluidised-bed jet mill typically has a grinding chamber where gas nozzles are arranged radially in the chamber wall and form fluidised bed. The jet milling may comprise fluidised bed jet milling. The jet milling may be achieved without the use of spiral jet milling (e.g. it may consist of fluidised bed jet milling).

Classification is typically achieved by air classification, e.g. using a centrifugal forced vortex air classifier. The desired particle size distribution may be achieved by controlling the process parameters e.g. the centrifugal force and suction force for filtering powder with certain particle size.

Other common methods for powder comminution are impaction millings and high-shear millings. In impaction milling, powdered material is milled by mechanical impaction with a high velocity component, which could be gravitational energy (hammer mill), or kinetic energy (high speed rotor/stator/pin etc.). High shear milling consists of a rotating container or a rotor, so the grinding component and powder material interacts with shear force to reduce particle size.

A material which has been jet milled and classified as opposed to other powder comminution methods may be identified by SEM. Specifically, an SEM image of a material which has been jet milled and classified to the particle size parameters defined herein will be homogenous, free from the very fine particles and from larger particles which may be expected in an SEM image of a material comminuted by other methods. Electrodes comprising the processed H—Nb₂O₅ material may be identified as having a homogenous surface, free from large cavities and large particles.

The processed H—Nb₂O₅ material has a D₅₀ particle diameter of 2.2-15 μm; or optionally 2.5-12 μm, 3.0-10 μm, or 4.0-8.0 μm.

The processed H—Nb₂O₅ material has a particle size distribution span (D₉₀−D₁₀)/D₅₀ of <1.90; or optionally <1.80, <1.60, or <1.50. For example, the particle size distribution span (D₉₀−D₁₀)/D₅₀ may be in the range of >0.2 to <1.90 or >0.5 to <1.50.

The combination of the D₅₀ particle diameter and the span in the specific ranges defined herein, for a material processed by jet milling and classification, have been found to improve the properties of a H—Nb₂O₅ material for use as an active electrode material. For instance, as shown by the present examples, a significant improvement in capacity at high de-lithiation rates of e.g. 5 C and 10 C is provided, compared to alternative particle size parameters and milling methods. It is theorised that particle size and distribution of active electrode materials directly impact the performance of Li-ion cells in several aspects: 1) Conductivity. Active electrode materials with larger particle sizes and broad distributions lead to non-uniform electrodes and poor processability at industrial scale by e.g. roll-to-roll coating processes, which in turn results in poor electronic conductivity of the electrode, and not consistent performance. Moreover, larger particle sizes have a longer Li-ion diffusion path, decreasing the performance of the cell at high rates. 2) Side reactions. Active electrode materials with small particle sizes correspond to high specific surface areas, causing more undesired side reactions with electrolyte, resulting in material degradation and short cycle life. The inventors have found that the specified D₅₀ particle size and particle size distribution span provide the optimum balance of these factors for H—Nb₂O₅. Moreover, the use of jet milling and classification has been found to be a particularly advantageous way of achieving these parameters. Conventional powdered material size reduction techniques include impaction milling and high shear milling. However, these two types of milling are prone to inducing contamination due to direct contact between the powder and the milling media, and have poor size distribution control at <20 μm particle sizes. Jet milling and classification avoids these issues, and by control of the processing parameters (e.g. the centrifugal force and suction force), the desired particle size parameters can be readily obtained. Accordingly, the combination of the particle size parameters, when achieved by jet milling and classification, has been found to lead to a surprising improvement in the properties of H—Nb₂O₅ for use as an active electrode material.

An additional definition of the particle size distribution span is (D₉₅−D₅)/D₅₀. The processed H—Nb₂O₅ material may have a particle size distribution span (D₉₅−D₅)/D₅₀ of <2.50, <2.25, or <2.0. For example, the particle size distribution span (D₉₅−D₅)/D₅₀ may be in the range of >0.3 to <2.50 or >0.6 to <2.0.

The processed H—Nb₂O₅ material has a D₁₀ particle diameter of >0.7 μm, 1.0-8.0 μm, or 1.5-4.0 μm. The processed H—Nb₂O₅ may have a D₉₀ particle diameter of <30 μm, 4.5-20 μm, or 5.5-15 μm. The processed H—Nb₂O₅ material may have a BET surface area of >0.7 m²/g, or 1-20 m²/g, or 0.8-2.50 m²/g.

The H—Nb₂O₅ crystal structure is preferably maintained following the jet milling and classification. Accordingly, the processed H—Nb₂O₅ material may have a phase purity of >80 wt % H—Nb₂O₅, >90 wt % H—Nb₂O₅, or >95 wt %, or about 100 wt % H—Nb₂O₅. The processed H—Nb₂O₅ material may be substantially pure H—Nb₂O₅. There may be some changes in the relative intensity of the characteristic peaks of the H—Nb₂O₅ crystal structure following the jet milling and classification, which may result from the introduction of defects into the crystal structure via the milling process. The intensity ratio of the peak in the XRD pattern of the processed H—Nb₂O₅ material at about 23.7°2θ to the peak at about 24.4°2θ may be in the range of 0.7-1.3 or 0.8-1.2.

The processed H—Nb₂O₅ material is formed into an electrode such that the processed H—Nb₂O₅ material is an active electrode material. An active electrode material may be understood to mean a material which can chemically react with lithium ions to store and release them reversibly in a controlled manner. The electrode is typically of the form of an electrode composition in electrical contact with a current collector. A current collector is typically a metal foil, e.g. copper or aluminium foil. The electrode may be made by forming a slurry of the processed H—Nb₂O₅ material and a solvent. The slurry may comprise at least one other component selected from a binder, a conductive additive, a different active electrode material, and mixtures thereof. The slurry may be deposited onto a current collector and the solvent removed, thereby forming an electrode composition on the current collector. Further steps, such as heat treatment to cure any binders and/or calendaring of the electrode layer may be carried out as appropriate. For example, the solvent may be removed by drying e.g. at temperatures of 30-100° C. The electrode may be calendared to a density of 2-3.5 or 2.3-2.9 g cm⁻³. The electrode composition may form a layer with a thickness in the range of from 5 μm to 2 mm, preferably 5 μm to 1 mm, preferably 5 μm to 500 μm, preferably 5 μm to 200 μm, preferably 5 μm to 100 μm, preferably 5 μm to 50 μm.

Alternatively, the slurry may be formed into a freestanding film or mat comprising the active electrode material, for instance by casting the slurry onto a suitable casting template, removing the solvent, and then removing the casting template. The resulting film or mat is in the form of a cohesive, freestanding mass which may then be bonded to a current collector by known methods.

Optionally, the processed H—Nb₂O₅ material forms at least 10 wt. %, 50 wt. %, or 75 wt. % of the total active electrode material in the electrode. The processed H—Nb₂O₅ material may form the sole active anode material in the electrode.

The electrode composition may further comprise at least one other component selected from a binder, a conductive additive, a different active electrode material, and mixtures thereof. For instance, one electrode composition comprises about 92 wt % processed H—Nb₂O₅ material, about 5 wt % conductive additive (e.g. carbon black), and about 3 wt % binder (e.g. poly(vinyldifluoride)), based on the total dry weight of the anode composition.

Examples of suitable binders include polyvinylidene fluoride and its copolymers (PVDF), polytetrafluoroethylene (PTFE) and its copolymers, polyacrylonitrile (PAN), poly(methyl)methacrylate or poly(butyl)methacrylate, polyvinyl chloride (PVC), polyvinyl formal, polyetheramide, polymethacrylic acid, polyacrylamide, polyitaconic acid, polystyrene sulfonic acid, polyacrylic acid (PAA) and alkali metal salts thereof, modified polyacrylic acid (mPAA) and alkali metal salts thereof, cellulose-based polymers, carboxymethylcellulose (CMC), modified carboxymethylcellulose (mCMC), sodium carboxymethylcellulose (Na-CMC), polyvinylalcohol (PVA), alginates and alkali metal salts thereof, butadieneacrylonitrile rubber (NBR), hydrogenated form of NBR (HNBR), styrene-butadiene rubber (SBR) and polyimide. The binder may be present in the electrode composition at 0-30 wt %, or 0.1-10 wt %, or 0.1-5 wt %, based on the total dry weight of the electrode composition.

Conductive additives are preferably non-active materials which are included so as to improve electrical conductivity between the active electrode material and between the active electrode material and the current collector. The conductive additives may suitably be selected from graphite, carbon black, carbon fibers, vapor-grown carbon fibres (VGCF), carbon nanotubes, graphene, acetylene black, ketjen black, metal fibers, metal powders and conductive metal oxides. Preferred conductive additives include carbon black and carbon nanotubes. Conductive additives may be present in the electrode composition at 0-20 wt %, 0.1-10 wt %, or 0.1-5 wt %, based on the total dry weight of the electrode composition.

The processed H—Nb₂O₅ material may be present in the electrode composition at 100-50 wt %, 99.8-80 wt %, or 99.8-90 wt %, based on the total dry weight of the electrode composition. When the active electrode material is present at 100 wt. % of the electrode composition it may form a solid-state electrode.

When a different active anode material is present in addition to the processed H—Nb₂O₅ material, it may be selected from lithium titanium oxide, titanium niobium oxide, an oxide comprising niobium and at least one other cation, graphite, hard carbon, soft carbon, silicon, doped versions thereof, and mixtures thereof.

The processed H—Nb₂O₅ material may be subjected to further processes after the jet milling and classifying and before forming the electrode. For example, the processed H—Nb₂O₅ material may be coated with carbon, e.g. to improve its surface electronic conductivity and/or to prevent reactions with electrolyte. The processed H—Nb₂O₅ material may be coated with aluminium oxide, zirconium oxide, an oxide comprising niobium and at least one other cation, organic or inorganic fluorides, organic or inorganic phosphates, titanium oxide, lithiated versions thereof, and mixtures thereof.

The invention includes the method of the first aspect but omitting the step of forming an electrode comprising the processed H—Nb₂O₅ material as an active electrode material. For example, the invention includes a method of making an active electrode material, the method comprising: providing a starting H—Nb₂O₅ material; and jet milling and classifying the starting material to provide a processed H—Nb₂O₅ material having a D₅₀ particle diameter of 2.2-15 μm and a particle size distribution span (D₉₀−D₁₀)/D₅₀ of <1.90. The processed H—Nb₂O₅ material may then be used as an active electrode material when forming an electrode. The invention also includes a processed H—Nb₂O₅ material obtainable by this method.

The electrode may be incorporated into an electrochemical cell. Preferably, the electrochemical cell comprises the electrode as an anode, a cathode, and an electrolyte disposed between the anode and cathode. The electrochemical cell is preferably a metal-ion battery such as a lithium-ion battery or a sodium-ion battery, most preferably a lithium-ion battery.

The electrochemical cell may be formulated to have a N/P ratio >1, wherein N/P is defined as:

$$\frac{\begin{matrix}areal loading ( {mgcm}^{- 2} ) ( anode ) \times \\ \begin{matrix}active fraction ( wt \% ) ( anode ) \times \\ first lithiation capacity ( {mAhg}^{- 1} ) ( anode )\end{matrix}\end{matrix}}{\begin{matrix}\begin{matrix}areal loading ( {mgcm}^{- 2} ) ( cathode ) \times \\ active fraction ( wt \% ) ( cathode ) \times \end{matrix} \\ first delithiation capacity ( {mAhg}^{- 1} ) ( cathode )\end{matrix}}$$

The area loading mgcm⁻² is the dry loading of the electrode composition, no taking into account the current collector.

The active fraction (wt %) is the percentage of the dry electrode composition that is active material. The first lithiation/delithiation capacity (mAhg⁻¹) is the specific capacity at C/10 at 25° C. for the first lithiation cycle for the anode or the first delithiation cycle for the cathode measured on an equivalent half-cell with a Li-metal counter electrode. An equivalent half-cell can be understood to utilise the same electrode composition deposited at the same areal loading and active fraction as the full cell.

Cell charge rate is typically expressed as a “C-rate”. A 1 C charge rate means a charge current such that the cell is fully charged in 1 h, 10 C charge means that the battery is fully charged in 1/10th of an hour (6 minutes). C-rate may be defined from the reversible capacity of the cell within appropriate voltage limits, e.g. for a cell that exhibits 1.0 mAh cm⁻² capacity within the voltage limits of 1.2-3.15 V, a 1 C-rate corresponds to a current density applied of 1.0 mA cm⁻².

The first lithiation/delithiation capacity is measured on an equivalent half-cell. For the anode, the first constant current C/10 lithiation (discharge, negative current) capacity (vs Li/Li+) at 25° C. is measured. For the cathode, the first constant current C/10 delithiation (charge, positive current) capacity (vs Li/Li+) at 25° C. is measured.

N/P may be in the range of >1-2, or 1.01-1.5, or preferably 1.05-1.3. Alternatively, N/P may be ≤1, or <1, such as 0.7-0.95.

The cathode comprises an active cathode material which may be selected from nickel-based layered oxides of the class LiNi₁₋ₓMₓO₂ where M=Co, Mn, Al such as NMCs—lithium nickel manganese cobalt oxides, NCAs—lithium cobalt aluminium oxides, and LCOs—lithium cobalt oxides; and LNMOs—lithium nickel manganese oxides (e.g. LiNi_{0.5}Mn_{1.5}O₄). Active cathode materials are widely available from commercial suppliers. Active cathode materials may be doped with additional cations and/or anions.

The choice of the active electrode material can affect the appropriate voltage range, including for determining the first lithiation/delithiation capacity. For example, appropriate voltage ranges may be LNMO: 5.2-3V, upper cut off 5.2V; NCA, NMC, and LCO: 4.5-2.7V, upper cut off 4.5V; processed H—Nb₂O₅ material: 3-0V, lower cut off 0V. Narrower ranges may be LNMO: 5-3V, upper cut off 5V; NCA, NMC, and LCO: 4.3-2.7V, upper cut off 4.3V; processed H—Nb₂O₅ material: 3 V-1.0 V, lower cut off 1.0 V.

An appropriate voltage range may be determined empirically. For example, the voltage profile correlates to the change in energy state of the anode and cathode materials associated with removal or insertion of electrons and ions. The cut-off voltage for the cell may be selected to fall before a specific inflection point in the voltage profile which corresponds to a rise in energy state of one or both electrodes beyond a critical level which leads the crystal structure to decay to a lower energy structure at a rate which is significantly harmful to the cell's performance. The absolute voltage at which this happens is a function of the electrode potentials of both electrodes, but can be calculated by use of a common reference electrode and need not be determined experimentally for well-established material families with reliable standard electrochemical behaviour.

The cathode active material is preferably in particulate form, e.g. having a D₅₀ particle diameter in the range of 0.1-100 μm, or 0.5-50 μm, or 1-20 μm.

The electrolyte may include any material suitable for metal-ion battery operation, preferably lithium-ion battery operation. For example, the electrolyte may be a non-aqueous solution (e.g., an organic electrolytic solution). The electrolyte may include one or more non-aqueous solvents and a salt that is at least partially dissolved in the solvent. For example, the solvent may include an organic solvent, such as, e.g., ethylene carbonate (EC) and/or other carbonate-based solvents, or butyrate, or acetate, or mixtures thereof. The solvent may include 1 M LiPF₆ dissolved in an aprotic solvent mixture, such as a 1:1 by weight of a mixture of ethylene carbonate and other carbonate-based solvents or butyrate or acetate. Salts suitable for use in the invention include LiPF₆, LiSbF₆, LiBF₄, LiTFSI, LiFSI, LiAlCl₄, LiAsF₆, LiClO₄, LiGaCl₄, LiC(SO₂CF₃)₃, LiN(CF₃SO₂)₂, Li(CF₃SO₃), LiB(C₆H₄O₂)₂, LiBOB (lithium bis(oxalate) borate), and LiDFOB (lithium difluoro (oxalate) borate). Low-viscosity solvents (e.g., organic solvents) suitable for use in the electrolyte may include, but are not limited to ethyl methyl carbonate (EMC), dioxlane (DOL), ethyl acetate (EA); propylene acetate (PA); butyl acetate (BA); methyl butyrate (MB); ethyl butyrate (EB); dimethyl carbonate (DMC); diethyl carbonate (DEC); 1,2-dimethoxyethane (DME); tetrahydrofuran (THF); methyl acetate (MA); diglyme (DGL); triglyme; tetraglyme; cyclic carbonates; cyclic esters; cyclic amides; propylene carbonate (PC); methyl propyl carbonate (MPC); acetonitrile; dimethyl sulfoxide (DMS); dimethyl formamide; dimethyl acetamide; gamma-butyrolactone (GBL); and N-methyl-pyrrolidinone (NMP); as well as various mixtures or combinations thereof.

### EXAMPLES

Example 1 was obtained from a commercial supplier. It was milled to obtain Examples 2-9.

Examples 2, 3, and 7-9 were made by fluidised bed jet milling with wheel classification (Alpine fluidised bed opposed jet mill AFG 100 for Examples 2 and 7-9 and AFG 200 for Example 3).

Example 2 was milled at 4.5 bar pressure with 2.5 mm nozzle diameter. Classifier speed was set at 6000 rpm.

Example 3 was milled at 6 bar pressure with 5 mm nozzle diameter. Classifier speed was set at 6000 rpm.

Example 4 was made by spiral jet milling (MC DecJet® 100). Venture pressure was set at 9 bar and ring pressure was set at 8 bar. No classification was done for this example.

Example 5 was made by rolling ball milling with zirconia balls in a 5 L PTFE jar. Diameter of milling balls are 5 mm and 1 mm. Material to ball ratio is 10:1. Rolling speed was 400 rpm. Milling time of 5A was 4 hours and milling time of 5B was 12 hours.

Example 6 was made by impaction milling (Retsch ZM200 impaction mill) with continuous milling method. The milling speed was set at 18000 rpm.

Example 7 was milled at 5 bar pressure with 2.5 mm nozzle diameter. Classifier speed was set at 8000 rpm.

Example 8 was milled at 4 bar pressure with 2.5 mm nozzle diameter. Classifier speed was set at 10000 rpm.

Example 9 was milled at 4 bar pressure with 2.5 mm nozzle diameter. Classifier speed was set at 3000 rpm.

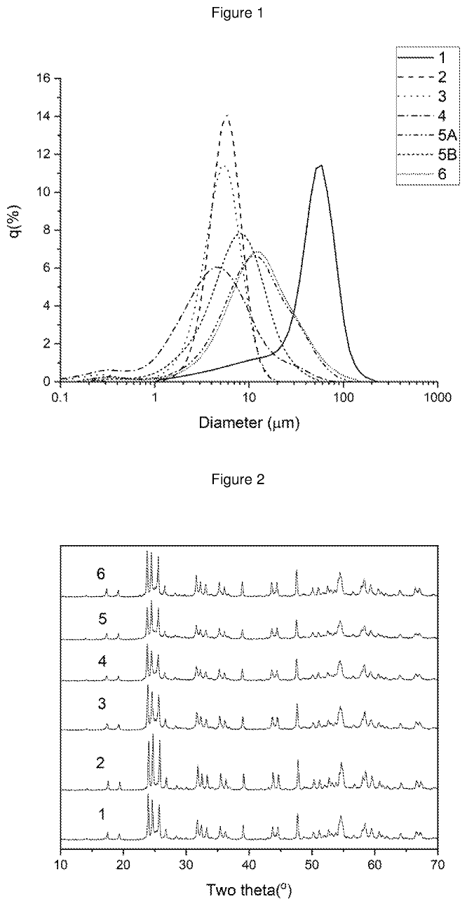

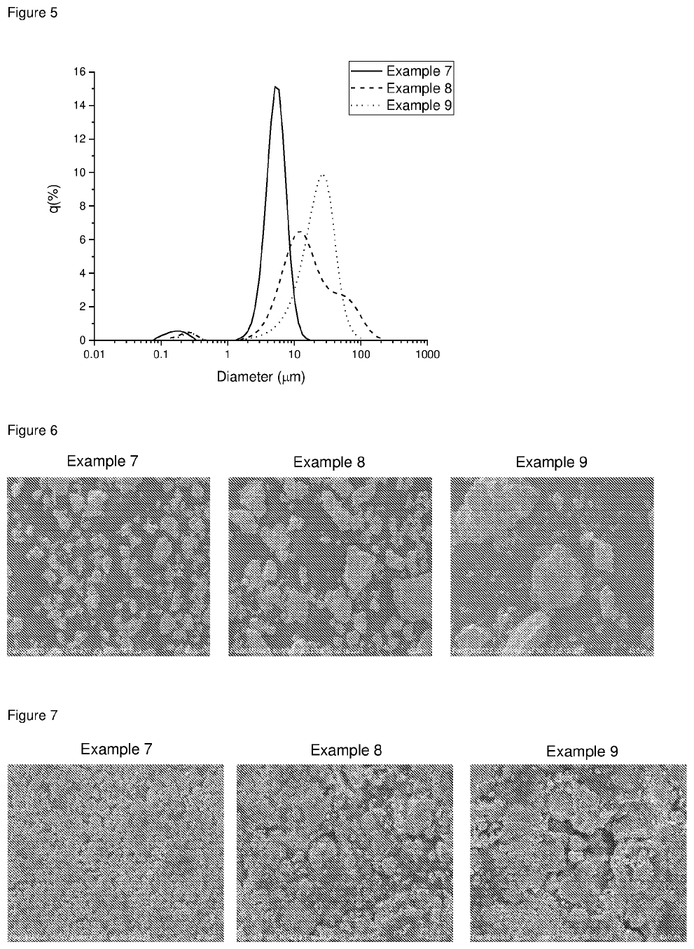

The particle size distribution of samples was measured using Horiba Partica LA-960 with a dry dispenser (FIGS. 1 and 5 and Table 1).

The surface area was measured using BET surface area analysis with N₂ on a BELSORP-miniX instrument at 77.35 K (Table 2).

TABLE 1
Particle size

| | | | | | | | (D₉₅ − D₅)/D₅₀ | (D₉₀ − D₁₀)/D₅₀ |
|---|---|---|---|---|---|---|---|---|
| | Description | D₅ | D₁₀ | D₅₀ | D₉₀ | D₉₅ | Span | Span |
| Example 1* | Starting | 5.4 | 10.3 | 46.4 | 82.0 | 96.0 | 1.95 | 1.55 |
| | H—Nb₂O₅ material | | | | | | | |
| Example 2 | Fluidised bed | 2.6 | 3.1 | 5.3 | 8.5 | 9.7 | 1.34 | 1.02 |
| | Jet milling with | | | | | | | |
| | classification | | | | | | | |
| Example 3 | Fluidised bed | 1.3 | 2.1 | 4.6 | 8.1 | 9.5 | 1.78 | 1.30 |
| | Jet milling with | | | | | | | |
| | classification | | | | | | | |
| Example 4* | Spiral jet | 0.4 | 1.0 | 3.9 | 11.2 | 16.1 | 4.02 | 2.62 |
| | milling | | | | | | | |
| Example 5A* | Rolling ball | 1.5 | 2.3 | 6.9 | 16.2 | 20.9 | 2.81 | 2.01 |
| | milling | | | | | | | |
| Example 5B* | Rolling ball | 0.4 | 0.5 | 2.2 | 4.8 | 5.7 | 2.36 | 1.95 |
| | milling | | | | | | | |
| Example 6* | Impaction | 2.2 | 3.6 | 11.2 | 33.6 | 45.1 | 3.83 | 2.68 |
| | milling | | | | | | | |
| Example 7 | Fluidised bed | 2.3 | 3.0 | 5.1 | 7.9 | 9.0 | 1.3 | 1.0 |
| | Jet milling with | | | | | | | |
| | classification | | | | | | | |
| Example 8* | Fluidised bed | 3.2 | 4.8 | 14.2 | 60.9 | 82.5 | 5.6 | 3.9 |
| | Jet milling with | | | | | | | |
| | classification | | | | | | | |
| Example 9* | Fluidised bed | 5.0 | 8.0 | 21.3 | 40.3 | 48.0 | 2.0 | 1.5 |
| | Jet milling with | | | | | | | |
| | classification | | | | | | | |

*Comparative

TABLE 2
Surface area

| | Example 1* | Example 2 | Example 4* | Example 5A* |
|---|---|---|---|---|
| BET Surface | 0.57 | 1.23 | 2.24 | 1.39 |
| Area (m²/g) | | | | |

### Materials Characterisation

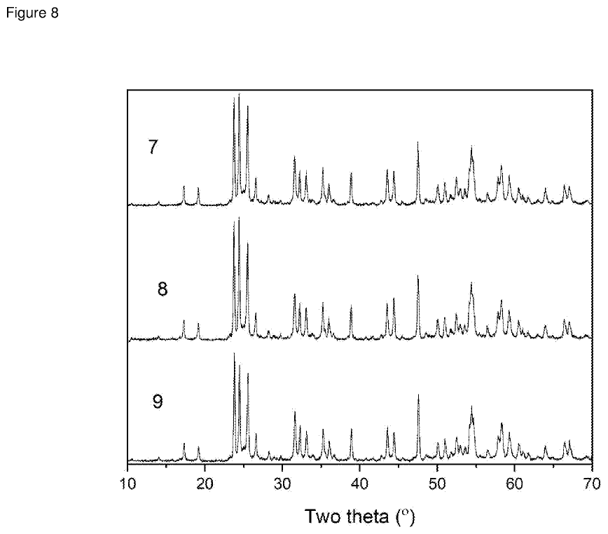

The phase purity of samples was analysed using a Rigaku Miniflex powder X-ray diffractometer in 20 range (10-70°) at 1°/min scan rate (FIGS. 2 and 8 and Table 3).

Example 1 was obtained as a starting H—Nb₂O₅ material with a phase purity of 100 wt %, as determined by XRD. The XRD patterns for all of the milled examples (2-9) show that the purity is maintained after the milling. Some differences in the relative intensity of the two characteristic peaks at ˜23.7° and ˜24.4° 2θ were observed, which may be due to differing levels of defects introduced into the H—Nb₂O₅ crystal structure.

TABLE 3
Intensity ratio of the peak at ~23.7° to the peak at ~24.4°

| Example | Intensity ratio |
|---|---|
| 1* | 1.13 |
| 2 | 0.86 |
| 3 | 1.18 |
| 4* | 1.25 |
| 5* | 0.82 |
| 6* | 1.05 |
| 7 | 0.96 |
| 8* | 0.96 |
| 9* | 1.12 |

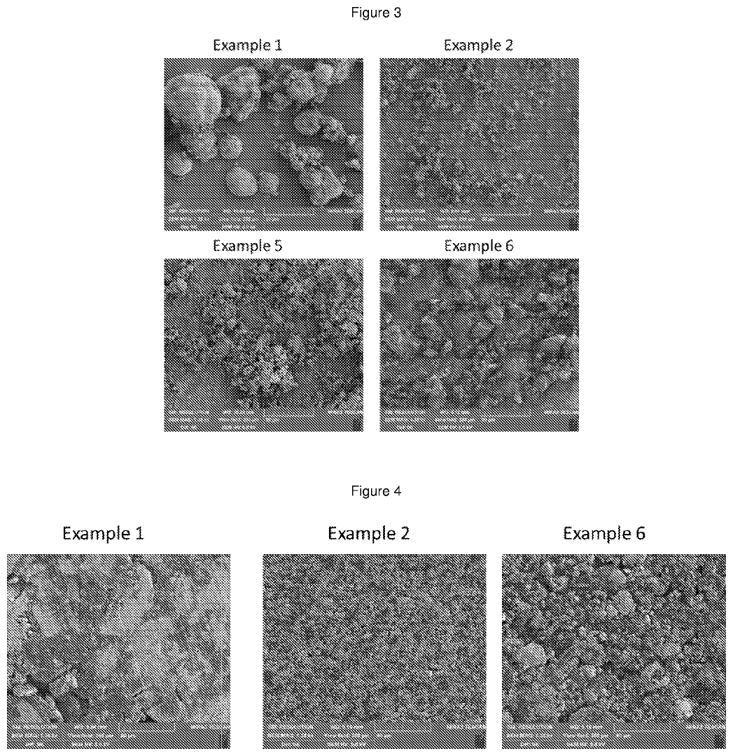

SEM results (FIGS. 3 and 6) showed that Example 1 had most spherical-shaped particles with largest particle size. Surface of these particles were composed of sintered primary particles. Example 2 showed particles with most homogeneous size. All particles in the SEM were below 15 μm. Particles in Example 5 showed much wider size distribution comparing with Example 2 with largest particle around 25 μm and smallest particle below 1 μm. Example 6 showed the second largest particle size among the four examples imaged, with some particles around 25 μm and unmilled particles presented. Example 7 showed homogenously-sized particles under SEM with all particles below 12 μm. Example 8 showed a wide spread of particle sizes with particles larger than 20 μm and particles smaller than 10 μm. Example 9 showed a majority of large particles with occasional particles smaller than 5 μm. These results are consistent with the particle size distribution results obtained from laser diffraction presented in Table 1.

When made into electrodes (FIGS. 4 and 7), powders with large particle size were unable to provide a homogenous electrode surface. The surface of the electrodes presented with too much polymer binder with large cavities (e.g., Example 1), damaging the conductivity, or large particles making the surface uneven (e.g, Example 6), damaging the cell's life. The electrodes prepared from Examples 8 and 9 showed an uneven surface with large cavities. In contrast, the electrode surface of Examples 2 and 7 are homogenous and free from large particles.

### Electrochemical Characterisation

Li-ion cell charge rate is usually expressed as a “C-rate”. A 1 C charge rate means a charge current such that the cell is fully charged in 1 h, 10 C charge means that the battery is fully charged in 1/10th of an hour (6 minutes). C-rate hereon is defined from the reversible capacity of the anode observed within the voltage limits applied in its second cycle de-lithiation, i.e. for an anode that exhibits 1.0 mAh cm⁻² capacity within the voltage limits of 1.1-3.0 V, a 1 C rate corresponds to a current density applied of 1.0 mA cm⁻². In a typical material as described herein, this corresponds to ˜215 mA/g of active material.

Electrochemical tests were carried out in half-coin cells (CR2032 size) for analysis. In half-coin cell tests, the active material is tested in an electrode versus a Li metal electrode to assess its fundamental performance. In the below examples, the active material composition to be tested was combined with N-Methyl Pyrrolidone (NMP), carbon black (Super P) acting as a conductive additive, and poly(vinylidenedifluoride) (PVDF) binder and mixed to form a slurry using a lab-scale centrifugal planetary mixer. The non-NMP composition of the slurries was 92 wt % active material, 5 wt % conductive additive, 3 wt % binder. The slurry was coated on an Al foil current collector to the desired loading of 69-75 g m⁻² by doctor blade coating and dried by heating. The electrodes were then calendared to a density of 2.5-2.7 g cm⁻³ at 80° C. to achieve targeted porosities of 32-37%. Electrodes were punched out at the desired size and combined with a separator (Celgard porous PolypropyleneP/PolyEthylene), Li metal, and electrolyte (1.3 M LiPF₆ in EthylCarbonate/DiethylCarbonate) inside a steel coin cell casing and sealed under pressure. Cycling was then carried out at 23° C. at low current rates (C/10) for 2 full cycles of lithiation and de-lithiation between 1.1-3.0 V. Afterwards, the cells were tested for their performance at increasing current densities. During these tests, the cells were cycled asymmetrically at 23° C., with a slow lithiation (C/5) followed by increasing de-lithiation rates (e.g. 1 C, 5 C, 10 C) to probe the capacity retention at high rates.

Data has been averaged from 3-5 cells prepared from the same electrode coating, with the error shown from the standard deviation. Accordingly, the data represent a robust study showing the improvements achieved by the materials according to the invention compared to prior materials. These data are shown in Tables 4a and 4b. The first cycle coulombic efficiency is defined as the percentage of the capacity of the first lithiation step which is returned in the first de-lithiation step and the formation capacity is defined as the capacity of the second de-lithiation step

TABLE 4a
Electrochemical data for Examples 1-6

| (mAh/g) | | Example 1* | Example 2 | Example 3 | Example 4* | Example 5A* | Example 5B* | Example 6* |
|---|---|---|---|---|---|---|---|---|
| 1st cycle | | 98%(1%) | 95%(0.2%) | 96%(0.1%) | 95%(0.1%) | 91%(0.1%) | 91%(0.1%) | 96%(0.0%) |
| CE | | | | | | | | |
| Formation | | 212(3) | 218(2) | 216(3) | 215(2) | 198(1) | 210(2) | 210(2) |
| capacity | | | | | | | | |
| 0.5 | C | 198(3) | 205(2) | 207(3) | 204(3) | 188(1.4) | 198(2.4) | 199(2) |
| 1 | C | 186(3) | 200(2) | 202(2) | 196(3) | 182(1) | 193(2.2) | 193(2) |
| 2 | C | 171(3) | 197(2) | 199(2) | 188(2) | 175(1) | 187(1.9) | 187(2) |
| 5 | C | 147(4) | 192(2) | 193(2) | 177(1) | 166(1.0) | 179(2.7) | 179(3) |
| 10 | C | 120(6) | 185(3) | 185(3) | 166(1) | 153(1) | 170(2.7) | 170(3) |

TABLE 4b
Electrochemical data for Examples 7-9

| (mAh/g) | Example 7 | Example 8* | Example 9* |
|---|---|---|---|
| 1st cycle | 96.8(0.3)% | 98.4(3.5)% | 97.9(2.2)% |
| CE | | | |
| Formation | 215.8(3.9) | 217.2(2.1) | 216.5(3.9) |
| capacity | | | |
| 0.5 C | 206.3(1.6) | 202.6(2.6) | 201.6(3.6) |
| 1 C | 200.9(1.6) | 194.7(2.4) | 195.0(3.7) |
| 2 C | 198.1(1.6) | 188.9(2.2) | 190.5(3.8) |
| 5 C | 195.2(1.7) | 181.6(1.9) | 184.0(3.6) |
| 10 C | 191.2(1.24) | 165.9(16.0) | 174.1(2.7) |

### DISCUSSION

Examples 2, 3, and 7 which were jet milled and classified according to the invention, were found to provide improved capacities at all de-lithiation rates when incorporated into an electrode, compared to the starting material of Example 1. Notably, Examples 2, 3, and 7 provided improved capacities at all de-lithiation rates compared to Example 4 (jet milled but not classified, thus having a higher particle size distribution span), Examples 5A and 5B (rolling ball milled), Example 6 (impaction milled), Example 8 (jet milled and classified, but having a higher particle size distribution span), and Example 9 (jet milled and classified, but having a higher D₅₀ particle size). The improvement provided by the invention is particularly apparent at the high de-lithiation rate of 10 C, an important result demonstrating the utility of the invention in providing a niobium oxide active electrode material for use in high-power applications.

1. A method of making an electrode, the method comprising:
providing a starting H—Nb₂O₅ material;
jet milling and classifying the starting material to provide a processed H—Nb₂O₅ material having a D₅₀ particle diameter of 2.2-15 μm and a particle size distribution span (D₉₀−D₁₀)/D₅₀ of <1.90; and
forming an electrode comprising the processed H—Nb₂O₅ material as an active electrode material.

2. The method of claim 1, wherein the processed H—Nb₂O₅ material has a particle size distribution span (D₉₅−D₅)/D₅₀ of <2.50, <2.25, or <2.0.

3. The method of claim 1, wherein the processed H—Nb₂O₅ material has a particle size distribution span (D₉₀−D₁₀)/D₅₀ of <1.80, <1.60, or <1.50.

4. The method of claim 1, wherein the processed H—Nb₂O₅ material has a D₅₀ particle diameter of 2.5-12 μm, 3.0-10 μm, or 4.0-8.0 μm.

5. The method of claim 1, wherein the processed H—Nb₂O₅ material has a D₁₀ particle diameter of >0.7 μm, 1.0-8.0 μm, or 1.5-4.0 μm.

6. The method of claim 1, wherein the processed H—Nb₂O₅ material has a D₉₀ particle diameter of <30 μm, 4.5-20 μm, or 5.5-15 μm.

7. The method of claim 1, wherein the processed H—Nb₂O₅ material has a BET surface area of >0.7 m²/g, or 1-20 m²/g, or 0.8-2.50 m²/g.

8. The method of claim 1, wherein the starting H—Nb₂O₅ material has a D₅₀ particle diameter of >20 μm, 25-150 μm, or 30-100 μm.

9. The method of claim 1, wherein the starting H—Nb₂O₅ material has a phase purity of >80 wt % H—Nb₂O₅, >90 wt % H—Nb₂O₅, or is substantially pure H—Nb₂O₅.

10. The method of claim 1, wherein the intensity ratio of the peak in the XRD pattern of the processed H—Nb₂O₅ material at about 23.7° 2θ to the peak at about 24.4° 2θ is in the range of 0.7-1.3 or 0.8-1.2.

11. The method of claim 1, wherein the jet milling comprises fluidised bed jet milling or spiral jet milling, or comprises fluidised bed jet milling, or consists of fluidised bed jet milling.

12. The method of claim 1, wherein the classifying is achieved by a centrifugal forced vortex air classifier.

13. The method of claim 1, wherein forming the electrode comprises forming a slurry of the processed H—Nb₂O₅ material in a solvent, depositing the slurry on a current collector, and removing the solvent.

14. The method of claim 13, wherein the slurry comprises at least one further component selected from a binder, a conductive additive, a different active electrode material, and mixtures thereof.

15. The method of claim 1, wherein the processed H—Nb₂O₅ material is coated with carbon before forming the electrode.

16. The method of claim 1, wherein the processed H—Nb₂O₅ material forms at least 10 wt. %, 50 wt. %, or 75 wt. % of the total active electrode material in the electrode.

17. The method of claim 1, wherein the processed H—Nb₂O₅ material is the sole active electrode material in the electrode.

18. The method of claim 1, further comprising forming an electrochemical cell comprising the electrode.

19. The method of claim 18, wherein the electrochemical cell comprises the electrode as an anode, a cathode, and an electrolyte disposed between the anode and cathode.

20. The method of claim 19, wherein the electrochemical cell is formulated to have a N/P ratio >1, wherein N/P is defined as:
$$\frac{\begin{matrix}areal loading ( {mgcm}^{- 2} ) ( anode ) \times \\ \begin{matrix}active fraction ( wt \% ) ( anode ) \times \\ first lithiation capacity ( {mAhg}^{- 1} ) ( anode )\end{matrix}\end{matrix}}{\begin{matrix}\begin{matrix}areal loading ( {mgcm}^{- 2} ) ( cathode ) \times \\ active fraction ( wt \% ) ( cathode ) \times \end{matrix} \\ first delithiation capacity ( {mAhg}^{- 1} ) ( cathode )\end{matrix}}$$
wherein:
areal loading (mgcm⁻²) is the dry loading of the electrode composition, not taking into account the current collector;
active fraction (wt %) is the percentage of the dry electrode composition that is active material;
first lithiation/delithiation capacity (mAhg⁻¹) is the specific capacity at C/10 at 25° C. for the first lithiation cycle for the anode or the first delithiation cycle for the cathode measured on an equivalent half-cell with a Li-metal counter electrode.

21. The method of claim 19, wherein the electrochemical cell is formulated to have a N/P ratio ≤1 wherein N/P is defined as:
$$\frac{\begin{matrix}areal loading ( {mgcm}^{- 2} ) ( anode ) \times \\ \begin{matrix}active fraction ( wt \% ) ( anode ) \times \\ first lithiation capacity ( {mAhg}^{- 1} ) ( anode )\end{matrix}\end{matrix}}{\begin{matrix}\begin{matrix}areal loading ( {mgcm}^{- 2} ) ( cathode ) \times \\ active fraction ( wt \% ) ( cathode ) \times \end{matrix} \\ first delithiation capacity ( {mAhg}^{- 1} ) ( cathode )\end{matrix}}$$
wherein:
areal loading (mgcm⁻²) is the dry loading of the electrode composition, not taking into account the current collector;
active fraction (wt %) is the percentage of the dry electrode composition that is active material;
first lithiation/delithiation capacity (mAhg⁻¹) is the specific capacity at C/10 at 25° C. for the first lithiation cycle for the anode or the first delithiation cycle for the cathode measured on an equivalent half-cell with a Li-metal counter electrode.

22. The method of claim 18, wherein the electrochemical cell is a metal-ion battery such as a lithium-ion battery or a sodium-ion battery, or wherein the electrochemical cell is a lithium-ion battery.

23. An electrode obtainable by the method of claim 1.

24. An electrochemical cell obtainable by the method of claim 18.
